(19) United States
(12) Patent Application Publication
(10) Pub. No.: US 2011/0121572 A1
(43) Pub. Date: May 26, 2011

(54) Wave Motion Power Generator

(76) Inventors: Leonid Levchets, Mequon, WI (US); Michael Levchets, Mequon, WI (US); Boris Levchets, Fox Point, WI (US)

(21) Appl. No.: 12/899,300

(22) Filed: Oct. 6, 2010

Related U.S. Application Data
(60) Provisional application No. 61/263,287, filed on Nov. 20, 2009.

(51) Int. Cl. F03B 13/20

(52) U.S. Cl. 290/53

(57) ABSTRACT

A power generation system is provided that can capture and convert kinetic energy from waves in open water into hydraulic or electrical energy. The system includes one or more platforms that include buoyant arms which extend outwardly from the platform for interaction with waves passing around and beneath the platform. The arms are pivotally secured to the platform and are capable of moving between points above and below the still water level in order to more effectively contact, i.e., float on, the waves as they pass. Opposite the waves, the arms are operably connected to a hydraulic system in order that the fluid in the hydraulic system is effectively pumped by the motion of the arms as a result of the movement of arms resulting from their interaction with the waves. In turn, the hydraulic fluid pumped by the arms serves to operate a hydraulic motor that drives an electric power generator that provides an easily transportable source of power that can be directed to any suitable power transfer station.

### CROSS-REFERENCE TO RELATED APPLICATIONS

This application claims priority from U.S. Provisional Application Ser. No. 61/263,287, filed on Nov. 20, 2009, the entirety of which is expressly incorporated by reference herein.

### FIELD OF THE INVENTION

The present invention relates to power generation devices, and more specifically to devices which generate power from the motion of waves.

### BACKGROUND OF THE INVENTION

Moving water has long been considered to be a potential and limitless source of ecologically safe power derived from the constant, and virtually perpetual motion of the water. In one application of this concept, the kinetic energy of water moving over or through a hydroelectric dam is utilized to generate electrical power. However, building a highly resource and time intensive structure across a river is often not practical, and the number of potential locations for such a structure is also limited.

As an alternative to a river as a source of power, attempts have been made in the past to harness the motion of waves in open water as they approach the shore. These attempts have focused on the capture of the kinetic energy from the tidal motion of the body of water and include tidal barrages, tidal fences, and tidal turbines. However, these approaches have certain significant drawbacks, such as expensive on-site installation and maintenance.

Still another alternative is the capture of the kinetic energy from the motion of the waves out in open water. The structures utilized for this purpose are most often constructed as floating platforms that have elements that interact directly with the waves as they pass the structure to convert the kinetic energy of the waves into a more directly useful form of energy.

These prior art platforms suffer from some significant drawbacks that prevent an effective and efficient capture of the energy from the waves. In particular, the elements on the platforms are only able to interact with the wave over a portion of the wave curve, meaning a significant portion of the energy carried by the wave is lost. This, in turn, makes the output of the platform much less efficient, and therefore, reduces the viability of the platform as an effective source of energy.

In addition, to effectively and efficiently capture the energy from the waves for conversion into useful forms of energy, the device interacting with the waves must be oriented with respect to the waves in a manner that most effectively interacts with the waves. In prior art devices, this has been difficult to achieve.

Therefore, it is desirable to develop a device for capturing and converting the kinetic energy of waves into a more directly useful form of energy, such as electrical energy, that can interact with the waves in a highly efficient manner to maximize the energy output of the device.

### SUMMARY OF THE INVENTION

According to a one aspect of the present invention, a power generation system is provided that can capture and convert kinetic energy from waves in open water into hydraulic or electrical energy. The system includes one or more platforms that include buoyant arms which extend outwardly from the platform for interaction with waves passing around and beneath the platform. The arms are pivotally secured to the platform and are capable of moving between points above and below the still water level in order to more effectively contact, i.e., float on, the waves as they pass. Opposite the waves, the arms are operably connected to a hydraulic system in order that the fluid in the hydraulic system is effectively activated by the motion of the arms as a result of the movement of arms resulting from their interaction with the waves. In turn, the hydraulic fluid pumped by the arms serves to operate an electric power generator via a hydraulic motor which provides an easily transportable source of power that can be directed to any suitable power transfer station.

According to another aspect of the present invention, the hydraulic system is configured to be operated by the arms when the arms move both above and below the still water level to maximize the energy output of the system. Further, the hydraulic system is operable as a result of the simultaneous and independent movement of each of the arms in the same or opposite directions, such that the hydraulic system generates fluid flow to operate the electric generator regardless of the individual positions of the arms.

According to a further aspect of the present invention, the configuration of the arms in the power generation system enable the arms to interact with waves approaching the system from virtually any direction, to maximize the movement of the arms, and the resulting power generation from the system. The configuration of the arms allows the power generation system to be deployed in any position with relation to the direction of the waves.

According to still another aspect of the present invention, the arms are each separately connected to the hydraulic system, such that each arm can be disconnected from the system for various reasons, while the remainder of the arms continue to provide the driving force to operate the hydraulic system.

According to still another aspect of the present invention, the apparatus allows for an uninterrupted and continuous energy source even when wave motion is minimal. At low wave heights, running a select number of motors allows for even the slightest wave motion to be captured into electricity.

Numerous other aspects, features, and advantages of the present invention will be made apparent from the following detailed description together with the drawings figures.

### BRIEF DESCRIPTION OF THE DRAWINGS

The drawings illustrate the best mode currently contemplated of practicing the present invention.

In the drawings:

FIG. 1 is an isometric view of a first embodiment of a power generation system constructed according to method of the present invention;

FIG. 2 is an isometric view of a second embodiment of the power generation system of FIG. 1;

FIG. 3 is a cross-sectional view along line 3-3 of FIG. 1;

FIG. 4 is a cross-sectional view along line 4-4 of FIG. 2;

FIG. 5 is a partially broken away, isometric view of the attachment of an arm to a platform of the system of FIG. 1;

FIG. 6 is a partially broken away, isometric view of the attachment of an arm to a platform of the system of FIG. 2;

FIG. 7 is a partially broken away side plan view of the operation of the arm of the system of FIG. 1;

FIG. 8 is a partially broken away side plan view of the operation of the arm of the system of FIG. 2;

FIG. 9 is a side plan view of the operation of the system of FIG. 1;

FIG. 10 is a side plan view of the operation of the system of FIG. 2;

FIG. 11 is a side plan view of the operating positions of a hydraulic cylinder of the system of FIG. 2;

FIG. 12 is a top plan view of a first embodiment of the arm of the system of FIG. 2;

FIG. 13 is a top plan view of a second embodiment of the arm of the system of FIG. 1;

FIG. 14 is a schematic view of the hydraulic system of the power generation system of FIG. 1;

FIGS. 15A-15C are schematic views of the operational conditions of the hydraulic system at the arm positions shown in FIGS. 7 and 8; and

FIGS. 16A-16D are top plan views of various arrangements of the power generation system of the present invention.

### DETAILED DESCRIPTION OF THE INVENTION

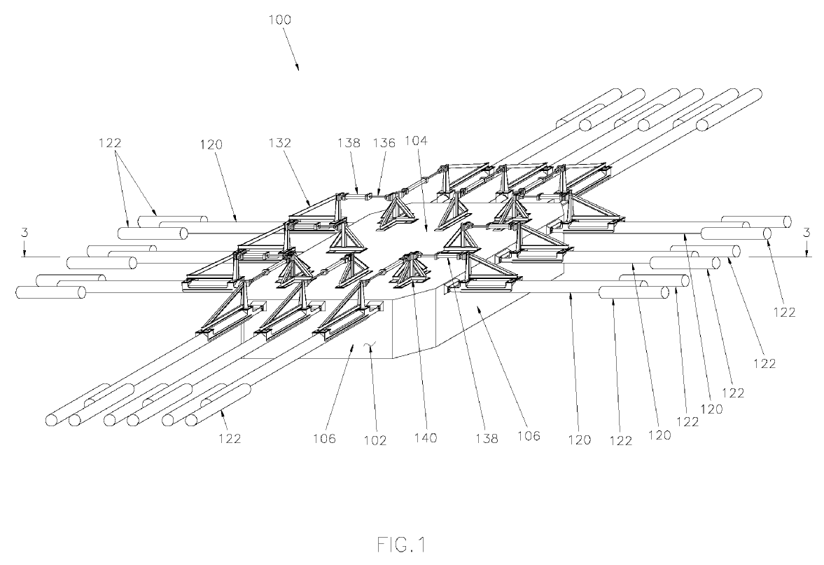

With reference now to the drawing figures in which like reference numerals designate like parts throughout the disclosure, a power generation system constructed according to the present invention is indicated generally at 100 in FIG. 1. The system 100 includes a platform 102 formed as a watertight enclosure of a suitable material capable of withstanding the harsh environment in which the platform 102 is located, such as a metal, including steel, aluminum, or their alloys, among others. The platform 102 is hollow, which provides the platform 102 with sufficient buoyancy to enable the platform 102 to float, and enables various additional components of the system 100 to be positioned therein. The shape of the platform 102 can vary as desired, and can be a cylinder or a prism, which is defined as a polyhedron with two congruent and parallel faces, and whose lateral faces are parallelograms.

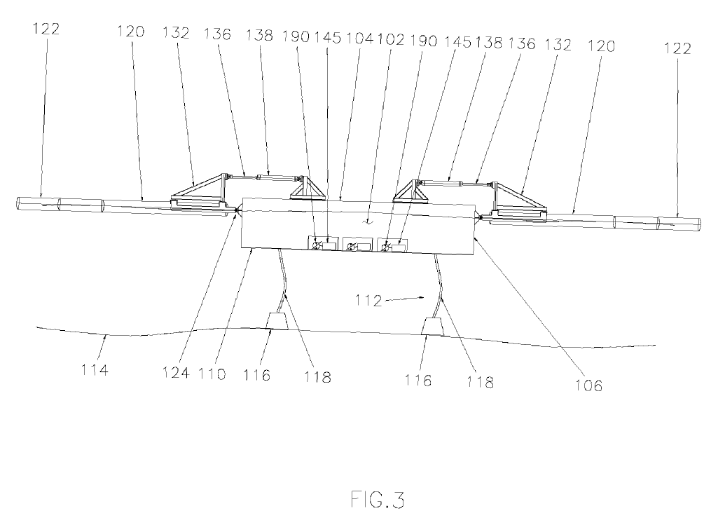

As best shown in FIGS. 1 and 3, one exemplary embodiment the platform 102 is generally square in shape and includes a top surface 104, a number of downwardly depending side surfaces 106 joined to the top surface 104, and a bottom surface 110 connected to the side surfaces 106.

To affix the platform 102 in a designated location, a number of mooring elements 112 are secured between the platform 102 and the floor 114 of the body of water on which the platform 102 is positioned. Each mooring element 112 includes a weight or base 116 which rests on the floor 114, and a cable or other suitable tethering member 118 that extends and is connected between the platform 102, e.g., the bottom surface 110, and the base 116. The mass of the base 116 is sufficient alone or in combination with additional bases 116 from additional mooring elements 112 to maintain the platform 102 in a relatively stationary location above the bases 116. Further, in one embodiment, the bases 116 are formed to simply rest on the surface of the floor 114, such that the bases 116 can be lifted off of the floor 114 when it is desired to reposition or remove the platform 102 from the body of water. The tethering members 118 are, in one embodiment, selected to have a length that enables the platform 102 to remain above the level of the highest wave height at a given location. The mooring elements 112 also are constructed and configured to avoid twisting about themselves or each other, and to prevent the tethering members 118 from interfering with other vessels, such as repair or maintenance vessels, that may approach the platform 102.

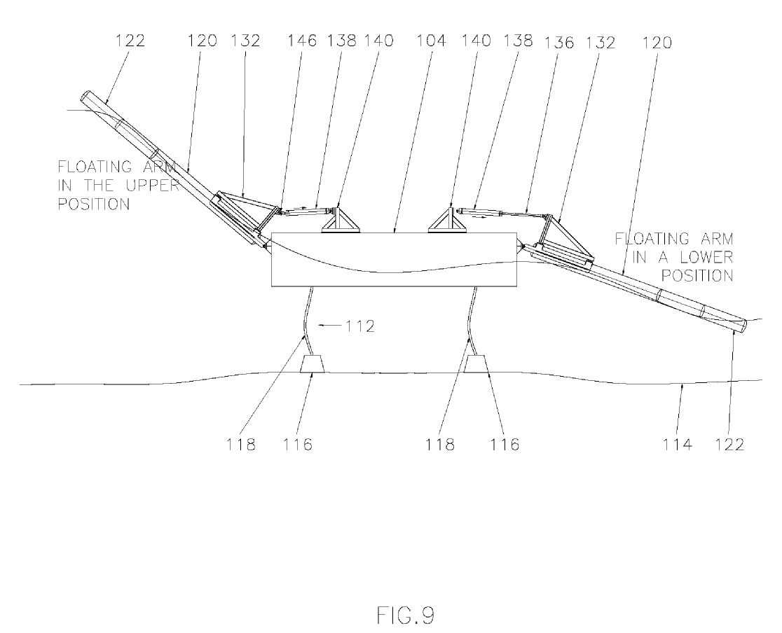

Referring now to FIGS. 1, 3, 5, 7, and 9, extending outwardly from each side surface 106 of the platform 102 are a number of arms 120. The arms 120 are each watertight, hollow and formed from a material similar to that of the platform 102 to enable the arms 120 to float on the surface of the body of water. Each arm 120 can be formed with any desired cross-section, such as conical, square, triangular or rectangular, but in one embodiment the arms 120 are generally formed to be tubular in shape. Each arm 120 can also include additional sections 122 affixed to the arm 120 at any point along the arm 120, with each section 122 being formed similarly to the arm 120.

Each arm 120 is connected to one side surface 106 of the platform 102 by a pivot 124, which can take a number of various forms, but in one embodiment is formed of a pillow block 126 secured to the side surface 106 and a clevis bracket 128 attached to the arm 120. The bracket 128 is rotatably secured to the pillow block 126 by a pin 130 engaged with the pillow block 126 and the clevis bracket 128.

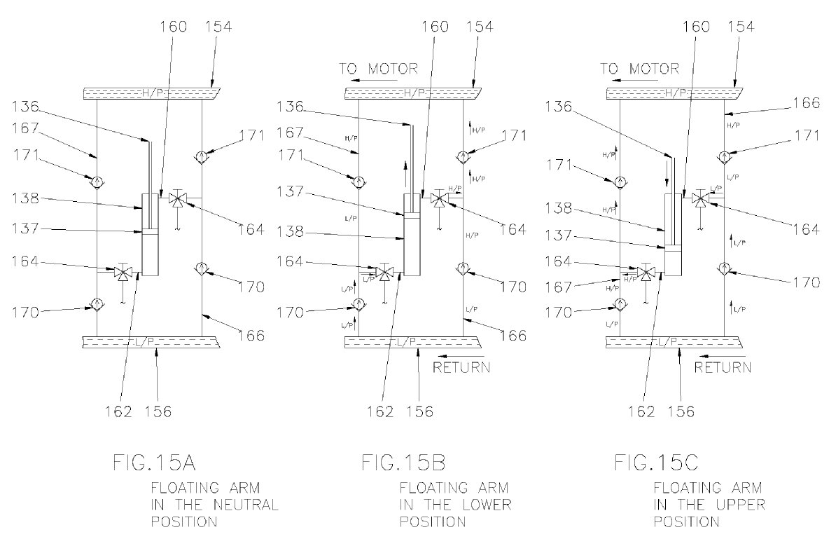

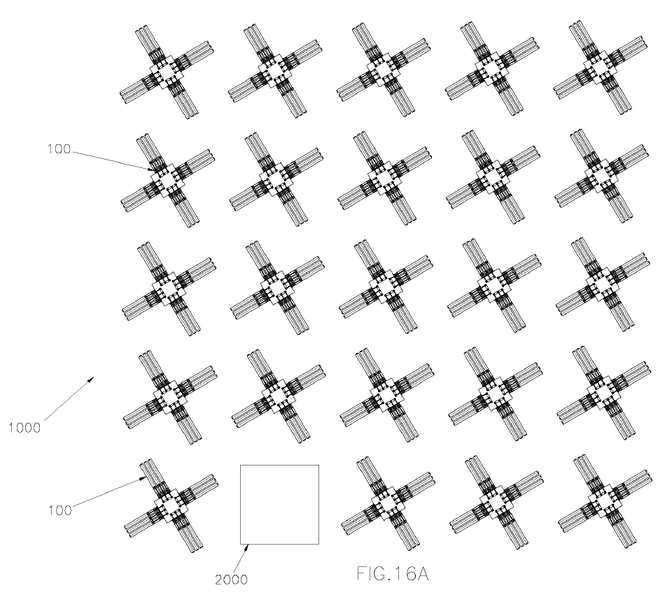

The clevis bracket 128 on each arm 120 forms a part of a connecting frame 132 affixed to the arm 120 adjacent the clevis bracket 128. The connecting frame 132 transmits force from the floating arm 120 to the hydraulic cylinders 138. The frame 132 includes an arm portion 133 that is attached directly to the arm 120, and a connecting portion 134 that extends upwardly from the arm portion 133. The frame 132 is formed similarly to the platform 102 and the arm 120 of a metal to be watertight. The connecting portion 134 of the frame 132 is attached to a cylinder rod 136 of a hydraulic cylinder 138 via a clevis bracket 128. The rod 136 includes a piston 137 (FIGS. 15A-15C) disposed within the cylinder 138 and sealing engaged with, but slidable with respect to the interior surface of the cylinder 138. In one embodiment, the piston 137 is disposed at the center of the cylinder 138 when the arm 120 is in the neutral position to maximize the amount of space and fluid that can be displaced by the piston 137 as it moves in either direction within the cylinder 138. The rod 136 and cylinder 138 extends from the frame 132 to a support 140 disposed on the top surface 104 of the platform 102. Alternatively, the position of the cylinder 138 could be reversed, with the rod 136 connected to the support 140 and the cylinder 138 connected to the frame 132. Alternatively, each arm 120 can be connected to more than one cylinder 138, or multiple arms 120 can be connected to a single cylinder 138.

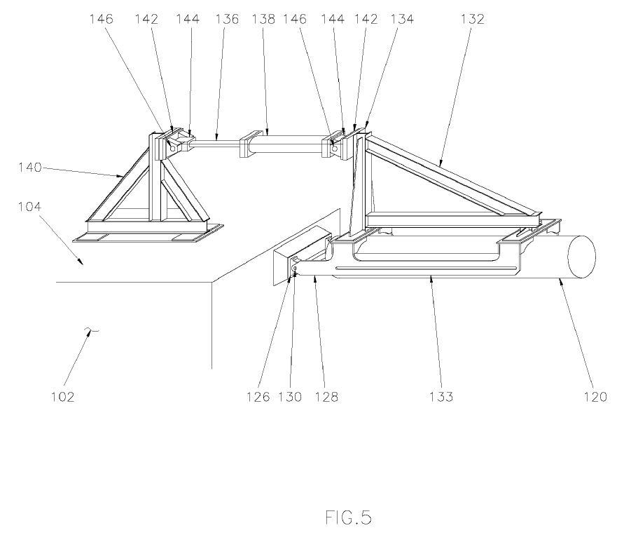

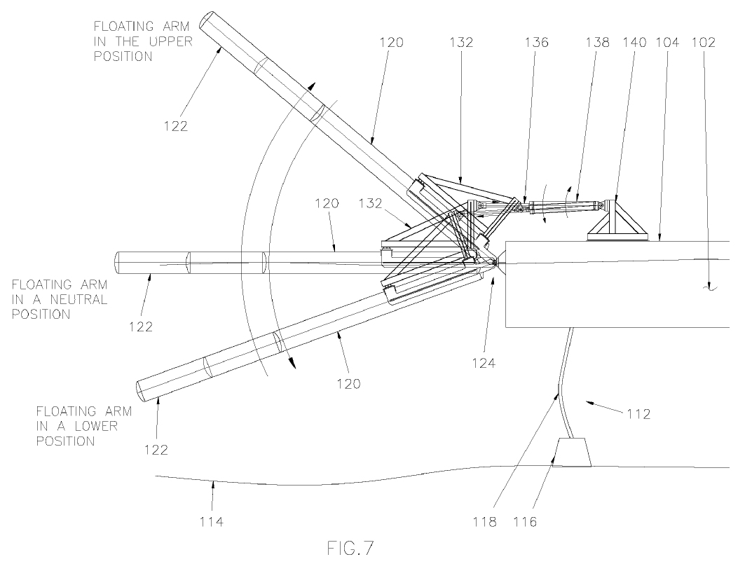

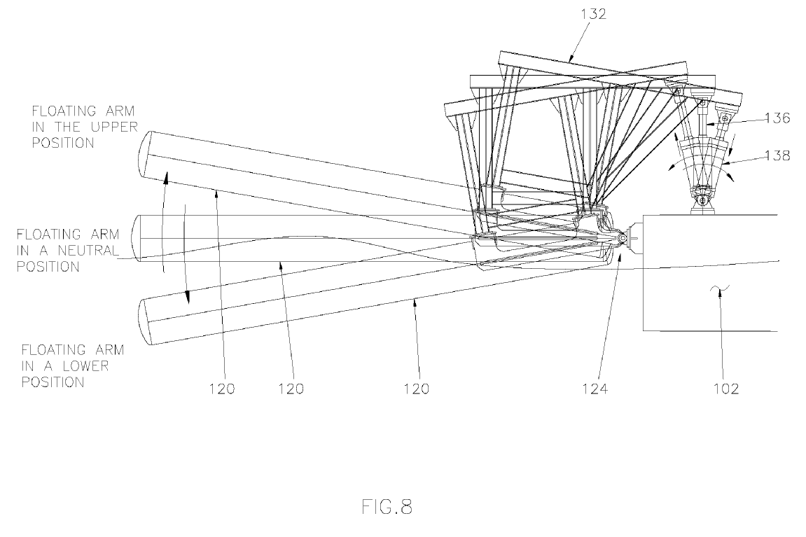

The rod 136 and the cylinder 138 are each affixed to the frame 132 and the support 140, or vice versa, utilizing clevis brackets 142 disposed on the connecting portion 134 of the frame 132 and the support 140, and tangs 144 located on the rod 136 and the cylinder 138, which are secured to one another utilizing pins 146, as best shown in FIG. 5. In this configuration, the rod 136 and cylinder 138 are able to pivot with respect to the frame 132 and support 140, as the arm 120 and frame 132 are pivoted with respect to the platform 102 by the interaction of the arm 120 with the waves on the body of water. This is best illustrated in FIGS. 7-9 where the pivoting of the rod 136 and cylinder 138 with respect to the frame 132 and support 140 as the arm 120 pivots with respect to the platform 102 between lower, neutral an upper positions of the arm 120.

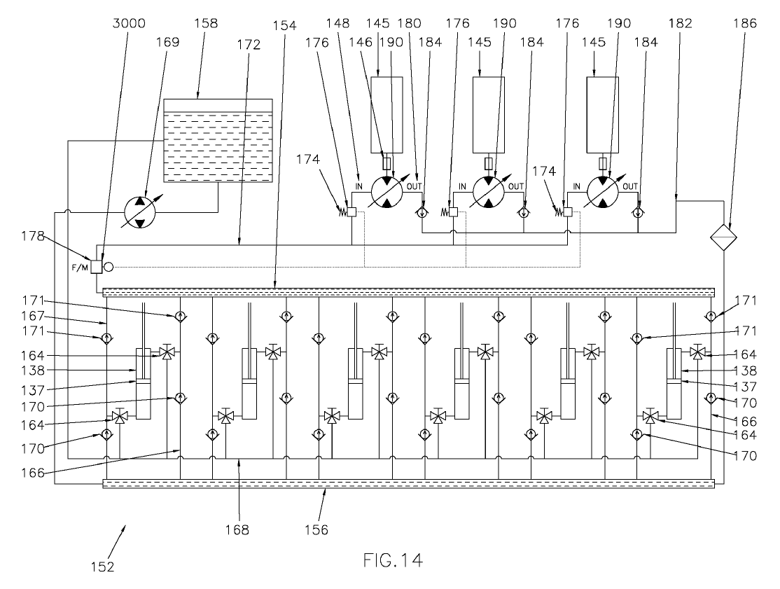

Referring now to FIGS. 3, 14 and 15A-15C, within the platform 102 are disposed a number of hydraulic motors 190 that are operably connected to electric generators 145, also located within the platform 102. The electric generators 145 are driven by the output of the hydraulic motors 190 through a suitable power transmission device 146, and the output from the generators 145 can be transmitted via any suitable means to a location separate from the platform 102 for use in a power grid or power station, or as an electrical supply for an offshore facility such as a data center or oil rig.

To operate the hydraulic motors 190, within the platform 102, each motor 190 has an inlet 148 and an outlet 180 connected to a hydraulic system 152, to which is also connected each of the cylinders 138. The hydraulic system 152 includes a high pressure manifold 154, and a low pressure manifold 156 connected to the high pressure manifold 154 and to a fluid reservoir 158.

To connect the cylinders 138 to the hydraulic system 152, each cylinder 138 includes a rod end port 160 and a cap end port 162 disposed at opposed ends of the cylinder 138. Each port 160, 162 is connected to a three-way valve 164 that can direct fluid into or out of the port 160, 162 to or from a conduit 166, 167 connecting the manifolds 156 and 154, or from the port 160, 162 to a conduit 168 connected to the reservoir 158. A hydraulic pump 169 is connected to the conduit 168 between the reservoir 158 and the low pressure manifold 156 to maintain proper levels of fluid in the system 152.

The conduits 166, 167 associated with each cylinder 138 and extending between the manifolds 156 and 154 each include a low pressure check valve 170 and a high pressure check valve 171 disposed in the conduits 166,167 on opposite sides of the connection point of the three way valve 164 to the conduit 166. The location and configuration of the valve 170 in each conduit 166, 167 allows low pressure fluid to flow from the low pressure manifold 156 to the cylinder 138, but prevents high pressure fluid from entering the low pressure manifold 156. Conversely, the location and configuration of the valve 171 in each conduit 166, 167 enables high pressure fluid from the cylinder 138 to enter the high pressure manifold 154, but prevents the flow of high pressure fluid from the high pressure manifold 154 into the low pressure manifold 156.

The high pressure manifold 154 is connected to the hydraulic motors 190 via a conduit 172 that is operably connected to the fluid input control 174 for each of the motors 190. The conduit 172 includes a control valve 176 located immediately upstream from each fluid input 174 which are operably connected to a flow meter 178 disposed adjacent the high pressure manifold 154. The flow meter 178, communicating with the fluid input control 174, can regulate the volume of fluid passing into each of the motors 190 independently of one another, in part depending upon the total volume of fluid in the system 152.

After the high pressure fluid from the manifold 154 has been utilized by the motors 190, the now-depressurized fluid passes via a fluid outlet 180 on each motor 190 into a conduit 182 that is connected to the low pressure manifold 156. The conduit 182 includes a check valve 184 disposed adjacent each outlet 180 to prevent the fluid from entering the motor 190 through the outlet 180. Additionally, the conduit 182 includes a filter 186 located upstream of the low pressure manifold 156 to filter the fluid prior to entering the low pressure manifold 156.

Referring now to FIGS. 7 and 15A-15C, when the arm 120 is disposed in the neutral position (FIG. 15A), and when the arms 120 are not interacting with the waves, the piston 137 in the cylinder 138 is stationary and no fluid is directed through the system 152. When the arm 120 moves downwardly to the lower position (FIG. 15B) as a result of the interaction of the arm 120 with a trough of a wave, the rod 136 is extended out of the cylinder 138, consequently drawing the piston 137 towards the port 160. The movement of the piston 137 in this direction compresses the fluid present in the cylinder 138 between the piston 137 and the end of the cylinder 138 through which the rod 136 extends to direct the high pressure fluid out of the cylinder 138 through the port 160. Upon exiting the port 160, the fluid enters the valve 164 and is directed into the conduit 166. In the conduit 166, the high pressure fluid is prevented from entering the low pressure manifold 156 due to the check valve 170, which is maintained closed as a result of the pressure exerted on the check valve 170 by the high pressure fluid. However, the check valve 171 is opened as a result of the high pressure fluid acting on it, such that the high pressure fluid can flow along the conduit 166 into the high pressure manifold 154. From the high pressure manifold 154, the high pressure fluid can be directed along the conduit 172 to the hydraulic motors 190 under the direction of the flow meter 178, as described previously.

Simultaneously, due to the low pressure created in the cylinder 138 between the piston 137 and the end of the cylinder 138 opposite the rod 136, low pressure fluid from the low pressure manifold 156 is drawn through the check valve 170 into the conduit 167, and through the valve 164 and port 162 into the cylinder 138. However, the bias of the check valve 171 is sufficient to prevent the valve 171 from being opened by the low pressure fluid, such that the valve 171 prevents the low pressure fluid from entering the high pressure manifold 154. The fluid exiting the low pressure manifold 156 is subsequently replenished from conduit 182 carrying the de-pressurized fluid from the motors 190.

When the arm 120 is acted upon by a wave to pivot the arm 120 upwardly with regard to the platform 102 (FIG. 15C), the system 152 operates in reverse, where the rod 136 is urged into the cylinder 138. This, in turn compresses the fluid in the cylinder 138 between the piston 137 and the closed end of the cylinder 138 opposite the rod 136. The pressurized fluid simultaneously exits the cylinder 138 through the port 162 and is directed through the valve 164 to the conduit 167. In the conduit 167, the fluid is prevented from passing into the low pressure manifold 156 by the low pressure check valve 170, but can pass into the high pressure manifold 154 though the valve 171.

Again, due to the low pressure created in the cylinder 138 between the piston 137 and the end of the cylinder 138 through which the rod 136 extends, low pressure fluid from the low pressure manifold 156 is drawn through the check valve 170 into the conduit 166, and through the valve 164 and port 160 into the cylinder 138. However, the bias of the check valve 171 is sufficient to prevent the valve 171 from being opened by the low pressure fluid, such that the valve 171 prevents the low pressure fluid from entering the high pressure manifold 154. The fluid exiting the low pressure manifold 156 is subsequently replenished from conduit 182 carrying the de-pressurized fluid from the motors 190.

In this manner, regardless of the direction of motion of the arm 120 in response to the interaction of the arm 120 with a wave, the system 152 operates to generate high pressure fluid flow that can be directed through the hydraulic motors 190. Further, as a result of the placement of the three way valves 164 adjacent each of the ports 160, 162, when an arm 120 is to be taken out of service, etc. for repair or maintenance, the valve 164 can be operated to direct the flow of fluid out of the cylinder 138 to the reservoir 158, bypassing the motors 190. Thus, any number of the arms 120 can be disconnected from the motors 190, while allowing the remainder to continue to operate the motors 190 via the hydraulic system 152.

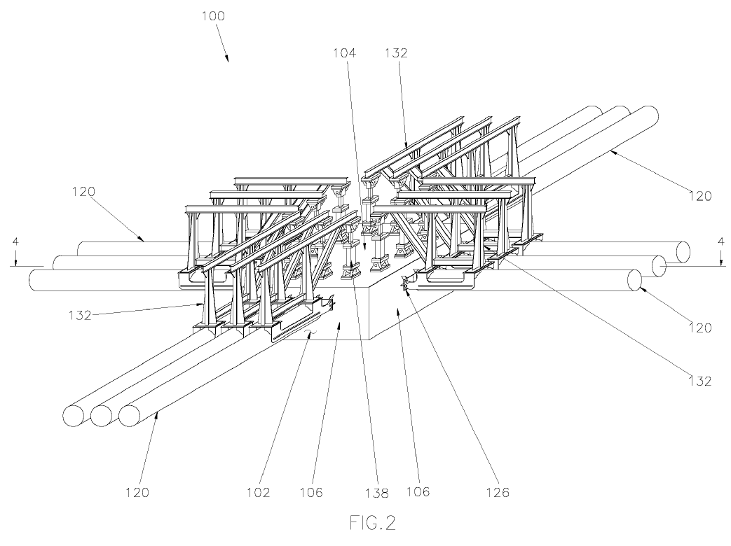

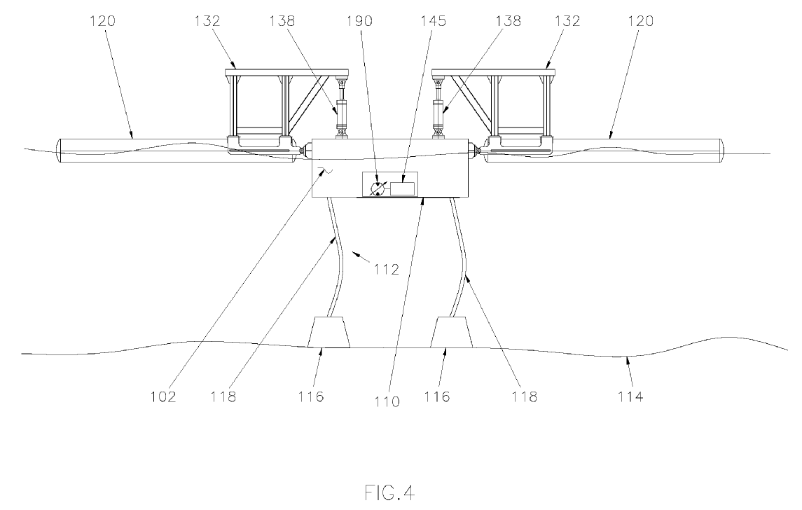

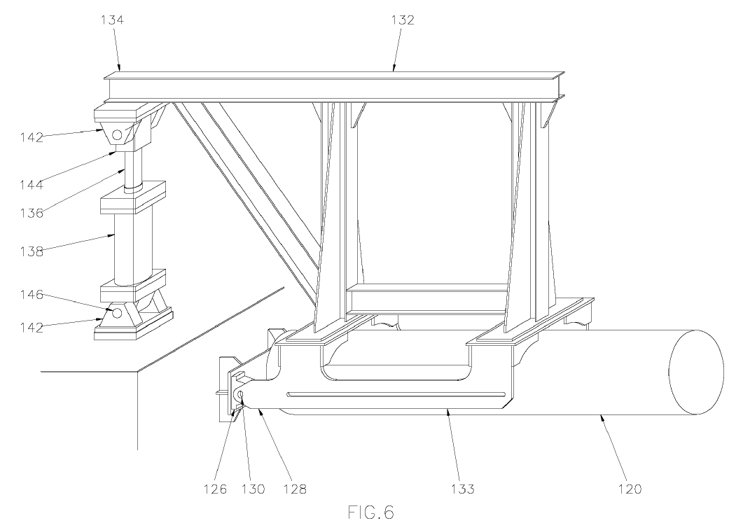

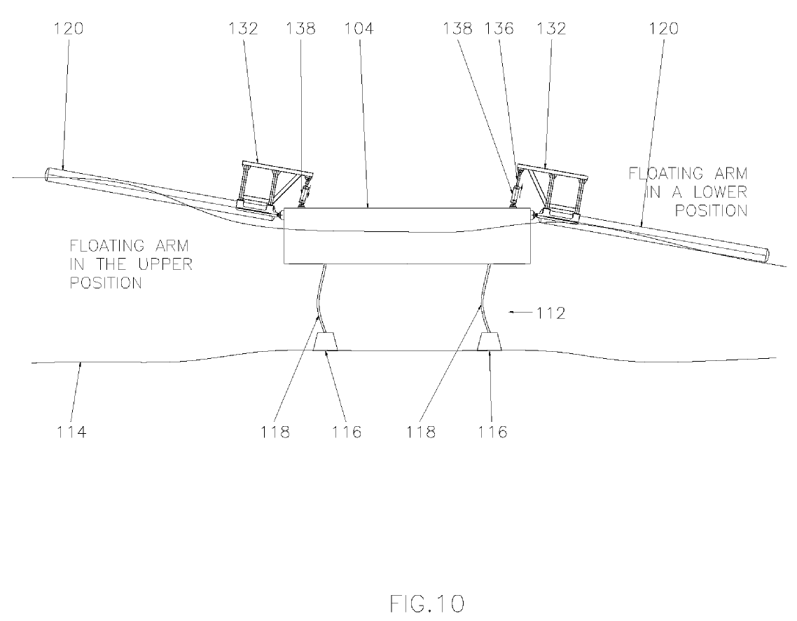

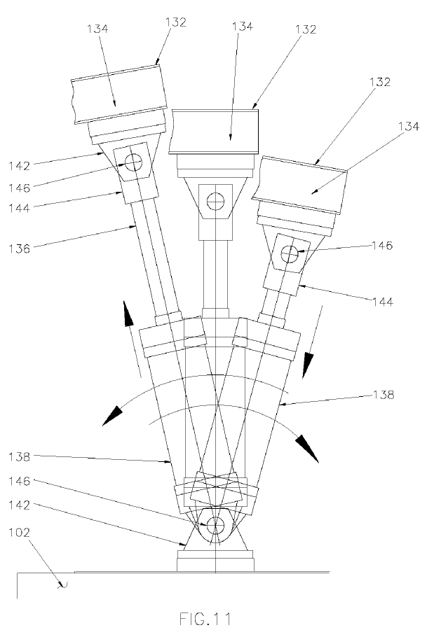

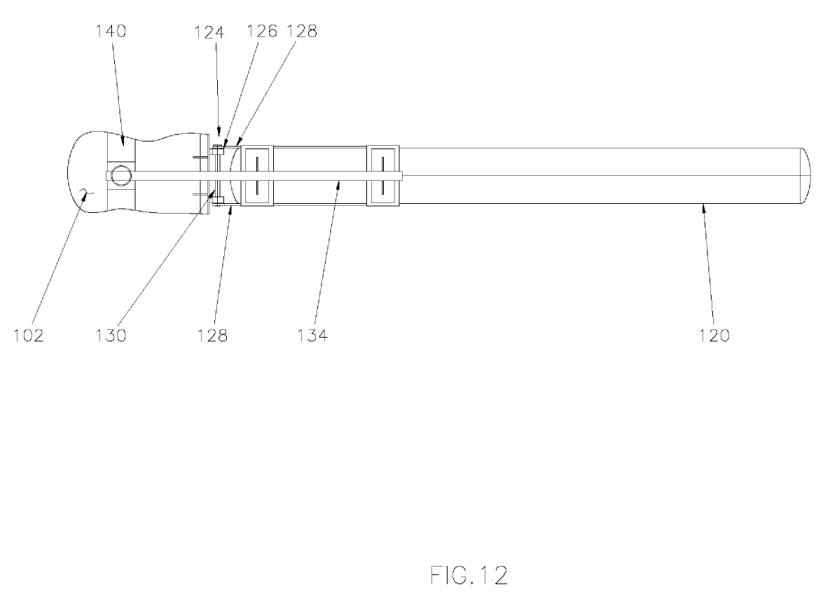

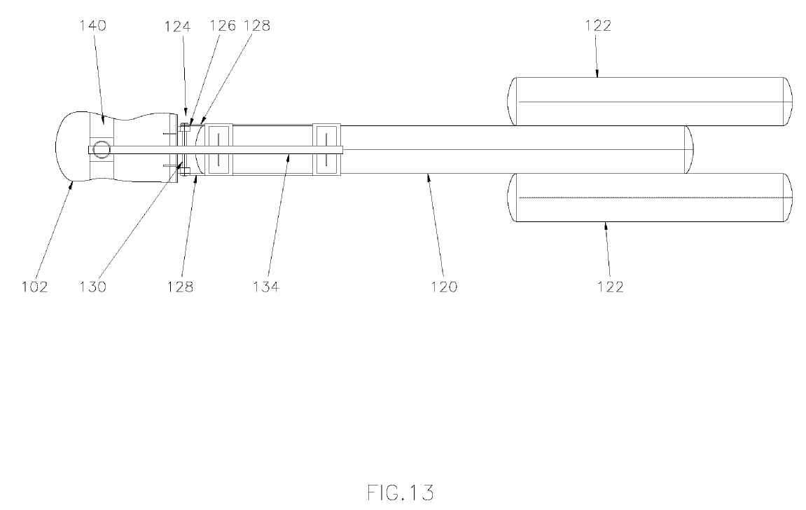

Looking now at FIGS. 2, 4, 6, 8 and 10, in a second embodiment of the invention, the connecting portion 134′ of the frame 132′ extends over the top surface 104′ of the platform 102′ such that the cylinder 138′ is oriented generally vertically and is connected directly to the top surface 104′ of the platform 102′ by a clevis bracket 142′ disposed on the cylinder 138′ and pivotally engaged with a clevis bracket 142′ disposed on the top surface 104′ by a pin 146′.

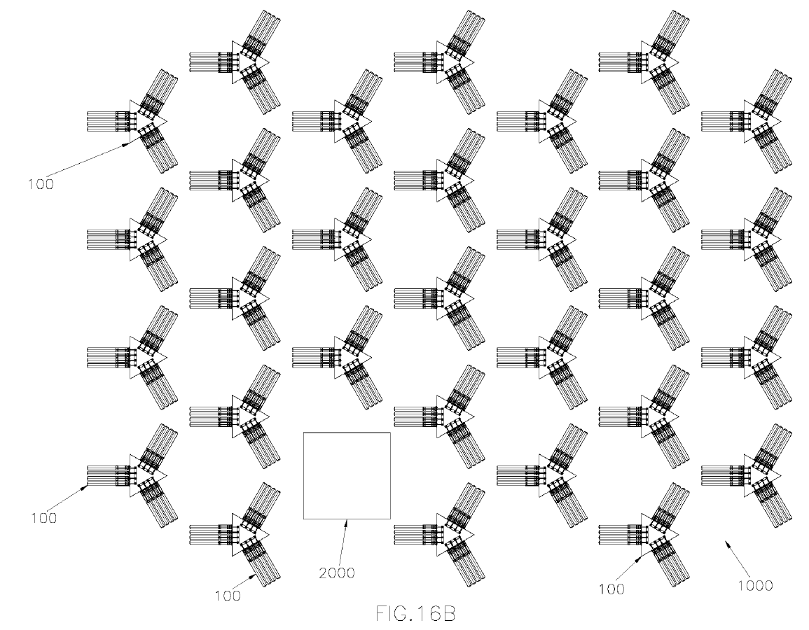

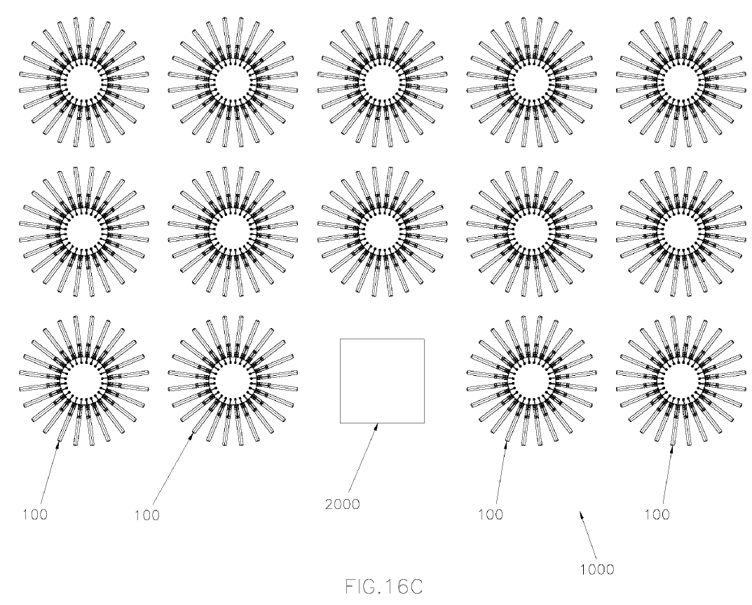

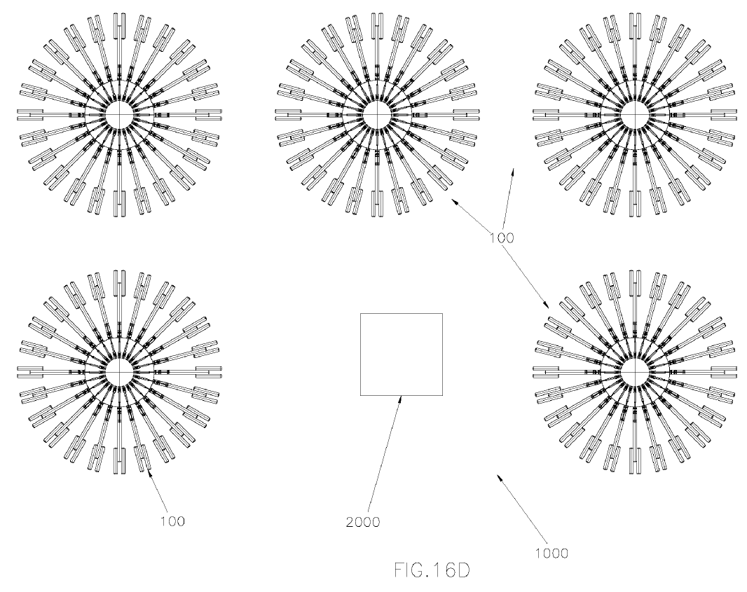

Referring now to FIGS. 16A-16D, various configurations for a power generation system 100 including a number of platforms 102 positioned in an array 1000 on the body of water. The platforms 102 have various cross-sectional shapes, with varying numbers of arms 120 extending outwardly from the sides 106 of the platforms 102 for interaction with the waves on the surface of the body of water. In each array 1000, an electric transformer station 2000 is disposed near the platforms 102 and is in operable connection with the electric generators 145 on each of the platforms 102 to capture and direct the electric energy created on each of the platforms 102. The preferred embodiment in FIG. 16D has a circular cross-sectional shape with additional tubular sections 122 affixed to the arms 120.

In alternative embodiments of the power generation system 100 of the present invention, the platforms(s) 102 can include a monitoring system 3000 that is operably connected to the hydraulic system 152 of the platform 102. The monitoring system 3000 is configured to determine the present operating condition of the various components of the platform 102 and selectively control the operation of the platform 102. For example, should any components of the hydraulic system 152 fail, e.g., a fluid leak, from the hydraulic system 152, or if a component of the system 100 becomes damaged, e.g., one of the arms 120 or the platform 102, the monitoring flow meter 178 bypasses the damaged component from remainder of the system 152. The monitoring system 3000 can also be configured to send out a signal, such as a wireless signal, via a transmitter to a suitable device, such as a computer or phone, among others, to indicate to an individual the presence of a failure on the platform 102 in order to enable the individual to initiate a repair. The monitoring system 3000 may also include a receiver to receive instructions, such as via a wireless signal, concerning the operation of the power generation system 100.

In addition, the monitoring system 3000 can selectively control the connection of one or more of the arms 120 to the hydraulic system 152 depending upon the wave conditions about the platform 102. For example, when performing maintenance tasks, the monitoring system 3000 can disconnect a number of the arms 120 and hydraulic motors 190 from the hydraulic system 152 by operating the three way valves 164. Alternatively, the monitoring system 3000 can reconnect the arms 120 and/or motors 190 to the hydraulic system.

Various other embodiments of the present invention are contemplated as being within the scope of the filed claims particularly pointing out and distinctly claiming the subject matter regarded as the invention.

1. A power generation system adapted to convert kinetic energy from waves on a body of water into electric energy, the system comprising:
a. a central platform capable of floating on the body of water and defining an interior;
b. at least one electric generator disposed within the interior of the platform;
c. at least one hydraulic motor disposed within the platform and operably connected to the at least one electric generator;
d. a hydraulic fluid system including a hydraulic fluid reservoir, a high pressure fluid manifold, a low pressure fluid manifold, a number of hydraulic cylinders, and a number of fluid conduits interconnecting the reservoir, the manifolds, the cylinders and the hydraulic motors, wherein a hydraulic fluid is adapted to flow along the conduits; and
e. a number of buoyant arms pivotally connected to the platform and operably connected to the cylinders, wherein movement of the arms operates the cylinders to drive the hydraulic fluid through the conduits to operate the hydraulic motors and the electric generators.

2. The system of claim 1 wherein each arm is operably connected to a single hydraulic cylinder.

3. The system of claim 1 wherein the platform has a number of lateral faces disposed around a perimeter of the platform, and wherein the arms are secured to each of the lateral faces in order to interact with waves approaching the platform around the entire perimeter of the platform.

4. The system of claim 1 further comprising a frame member secured to each arm at one end, and to the hydraulic cylinder at the opposite end.

5. The system of claim 4 wherein the frame member is pivotally secured to the hydraulic cylinder and fixed to the arm.

6. The system of claim 4 wherein the hydraulic cylinder is pivotally secured opposite the frame member to a support disposed on the platform.

7. The system of claim 4 wherein the hydraulic cylinder is a double acting hydraulic cylinder.

8. The system of claim 1 further comprising a transformer station located within or near the platform and operably connected to the at least one electric generator.

9. The system of claim 8 further comprising multiple platforms, wherein each of the at least one electric generators on the platforms is operably connected to the transformer station.

10. The system of claim 1 wherein the hydraulic cylinders are each connected to the conduits by three way valves that enable the cylinders to be selectively connected to the manifolds for power generation or to the reservoir for maintenance or repair.

11. The system of claim 10 further comprising a monitoring system operably connected to the hydraulic system and electrical system and capable of monitoring the operational characteristics of the hydraulic system components.

12. The system of claim 11 wherein the monitoring system is operably connected to the three way valves for each cylinder to selectively connect and disconnect the cylinders from the manifolds.

13. The system of claim 11 wherein the monitoring system is operably connected to a flow meter operably connected to the conduits and to a number of control valves disposed immediately upstream of each of the hydraulic motors.

14. A method of generating electric power from the kinetic energy of waves on a body of water, the method comprising the steps of:
a. placing at least one power generation system on the body of water, the system including a central platform capable of floating on the body of water and defining an interior, at least one electric generator disposed within the interior of the platform, at least one hydraulic motor disposed within the platform and operably connected to the at least one electric generator, a hydraulic fluid system including a hydraulic fluid reservoir, a high pressure fluid manifold, a low pressure fluid manifold, a number of control valves, a number of check valves, a number of hydraulic cylinders, and a number of fluid conduits interconnecting the reservoir, the manifolds, the cylinders and the hydraulic motors, wherein a hydraulic fluid is adapted to flow along the conduits, and a number of buoyant arms pivotally connected to the platform and operably connected to the cylinders, wherein movement of the arms operates the cylinders to drive the hydraulic fluid through the conduits to operate the hydraulic motors and the electric generators;
b. contacting the number of buoyant arms with the waves on the body of water to cause the arms to pivot with respect to the platform and operate the cylinders; and
c. directing a flow of hydraulic fluid from the cylinders through the hydraulic motors to operate the at least one electric generator and generate electricity.

15. The method of claim 14 further comprising the step of directing the electricity from the at least one electric generator to a transformer station.

16. The method of claim 14 wherein the power generation system includes a monitoring system operably connected to three way valves that interconnect the hydraulic conduits with the hydraulic cylinders, and further comprising the step of selectively connecting the hydraulic cylinders to the conduits simultaneously with directing the flow of fluid.
